(19) United States
(12) Patent Application Publication
(10) Pub. No.: US 2026/0312324 A1
(43) Pub. Date: Oct. 8, 2026

(54) CONNECTOR

(71) Applicant: YOKOWO CO., LTD., Chiyoda-ku, Tokyo (JP)

(72) Inventors: Kenta TAKAHASHI, Gunma (JP); Shogo HIRANO, Gunma (JP)

(73) Assignee: YOKOWO CO., LTD., Chiyoda-ku, Tokyo (JP)

(21) Appl. No.: 19/113,600

(22) PCT Filed: Sep. 13, 2023
(86) PCT No.: PCT/JP2023/033302

§ 371 Date: Mar. 20, 2025

(30) Foreign Application Priority Data
Sep. 20, 2022 (JP) 2022-149041

(51) Int. Cl. H01R 13/424; H01R 13/52

(52) U.S. Cl. CPC H01R 13/424; H01R 13/521

(57) ABSTRACT

A connector includes: a housing; a terminal that is accommodated in the housing, and a part of which extends to an outside of the housing. The housing includes a first housing portion having a terminal through hole through which a part of the terminal passes, and a second housing portion fixed to the first housing portion. The terminal is accommodated in an accommodating space formed by the first housing portion and the second housing portion in a state of partially passing through the terminal through hole by fixing the second housing portion to the first housing portion.

### TECHNICAL FIELD

The present invention relates to a connector.

### BACKGROUND ART

The following Patent Literature 1 discloses a connector having a structure in which a terminal is accommodated in a housing.

### CITATION LIST

### Patent Literature

Patent Literature 1: JP 5501143 B

### SUMMARY OF INVENTION

### Technical Problem

In the connector as disclosed in Patent Literature 1, an assembly procedure is used in which the terminal is provided inside the housing from the lower opening side of the housing, and the lower opening has a large opening area. The connector in Patent Literature 1 does not have a waterproof structure, and when the waterproof structure is to be made by sealing the lower opening of the housing of the connector, a problem occurs in the sealing structure by potting. For example, in order to prevent potting liquid such as resin from flowing into the terminal arrangement portion, a lid component needs to be placed over the lower opening of the housing to create a space to be filled with the potting liquid. However, the addition of a lid component causes the connector to become larger.

An example of an object of the present invention is to provide a technique that enables miniaturization of a connector with an improved waterproof property. Other objects of the present invention will become apparent based on the present description.

### Solution to Problem

An aspect of the present invention provides a connector including:
a housing; and
a terminal that is accommodated in the housing, and a part of which extends to an outside of the housing,
in which the housing includes a first housing portion having a terminal through hole through which a part of the terminal passes, and a second housing portion fixed to the first housing portion, and
in which the terminal is accommodated in an accommodating space formed by the first housing portion and the second housing portion in a state of partially passing through the terminal through hole by fixing the second housing portion to the first housing portion.

According to the above aspect of the present invention, it is possible to provide a technique that enables miniaturization of a connector with an improved waterproof property.

### BRIEF DESCRIPTION OF DRAWINGS

FIG. 1 is a perspective view of a connector 1 according to a first embodiment of the present invention, as viewed from above.

FIG. 2 is a perspective view of the connector 1 as viewed from below.

FIG. 3 is an exploded perspective view of the connector 1 as viewed from above.

FIG. 4 is an exploded perspective view of the connector 1 as viewed from below.

FIG. 5 is a front view of the connector 1.

FIG. 6 is a plan view of the connector 1.

FIG. 7 is an enlarged side cross-sectional view of the connector 1.

FIG. 8 is a cross-sectional view taken along a line VIII-VIII in FIG. 7.

FIG. 9 is a side cross-sectional view of a terminal press-fitting step of the connector 1.

FIG. 10 is a side cross-sectional view of a housing assembly step of the connector 1.

FIG. 11 is a side cross-sectional view of a potting step of the connector 1.

FIG. 12 is a perspective view of a connector 1A according to a second embodiment of the present invention, as viewed from above.

FIG. 13 is a perspective view of the connector 1A as viewed from below.

FIG. 14 is an exploded perspective view of the connector 1A as viewed from above.

FIG. 15 is an exploded perspective view of the connector 1A as viewed from below.

FIG. 16 is a plan view of the connector 1A.

FIG. 17 is an enlarged side cross-sectional view of the connector 1A.

FIG. 18 is a cross-sectional view taken along a line XVIII-XVIII in FIG. 17.

FIG. 19 is a side cross-sectional view of a terminal press-fitting step of the connector 1A.

FIG. 20 is a side cross-sectional view of a potting step of the connector 1A.

FIG. 21 is a side cross-sectional view of a housing assembly step of the connector 1A.

### DESCRIPTION OF EMBODIMENTS

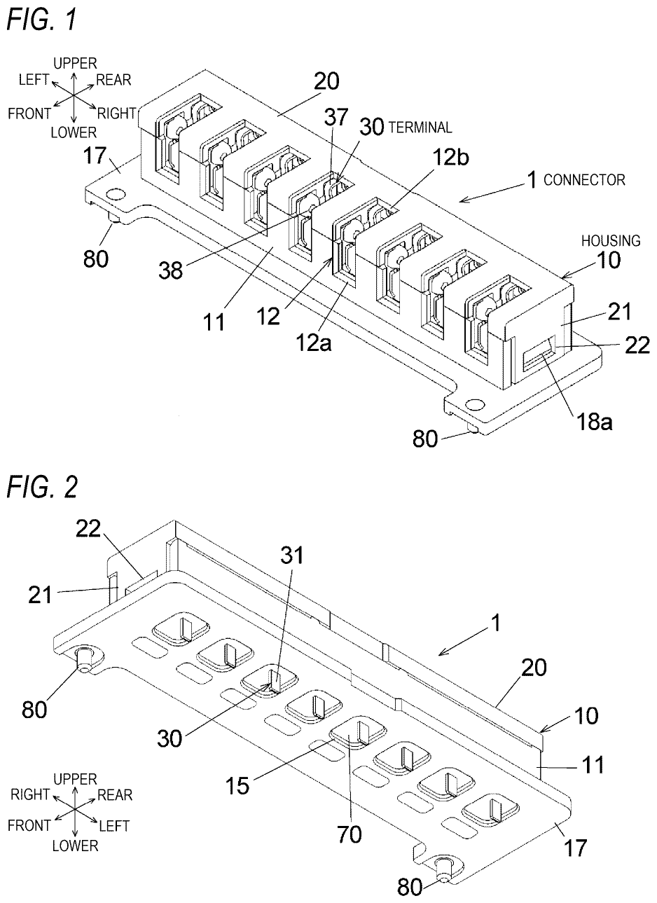

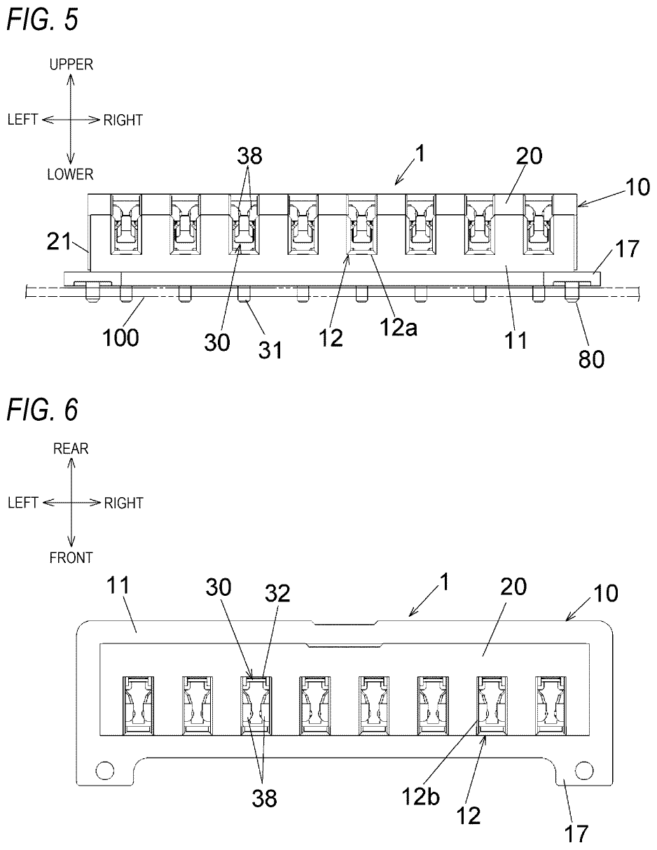

A connector according to a first embodiment of the present invention will be described with reference to FIGS. 1 to 11. A connector 1 according to the present embodiment is used for electrical connection. FIG. 1 defines the front-rear direction, the upper-lower direction, and the left-right direction of the connector 1 that are orthogonal to one another. The front-rear direction and the left-right direction are parallel to a board 100 (FIG. 5) on which the connector 1 is to be mounted. The upper-lower direction is a direction that is perpendicular to the board 100. The left-right direction is, when a plurality of terminals 30 are provided, the arrangement direction of the terminals 30.

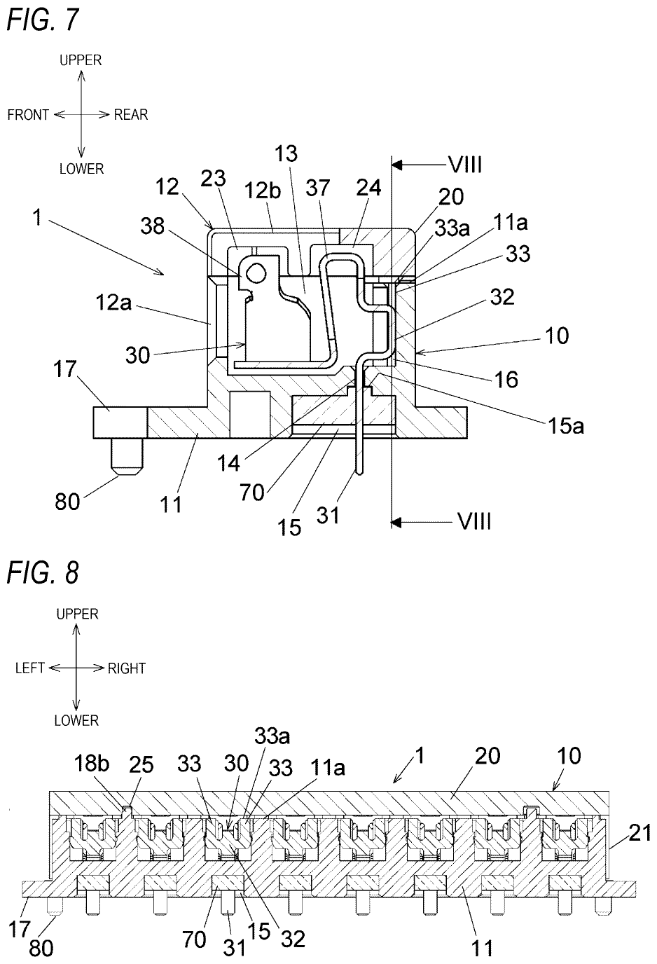

As shown in FIG. 7 and the like, the connector 1 includes an insulating housing 10, the conductive terminal 30 that is accommodated and held in the housing 10, and a sealing material 70 that seals in a watertight manner a part of the housing 10 that leads out the terminal 30. In the present embodiment, eight terminals 30 are provided as shown in FIGS. 1 to 6, and the number of terminals is not limited to eight.

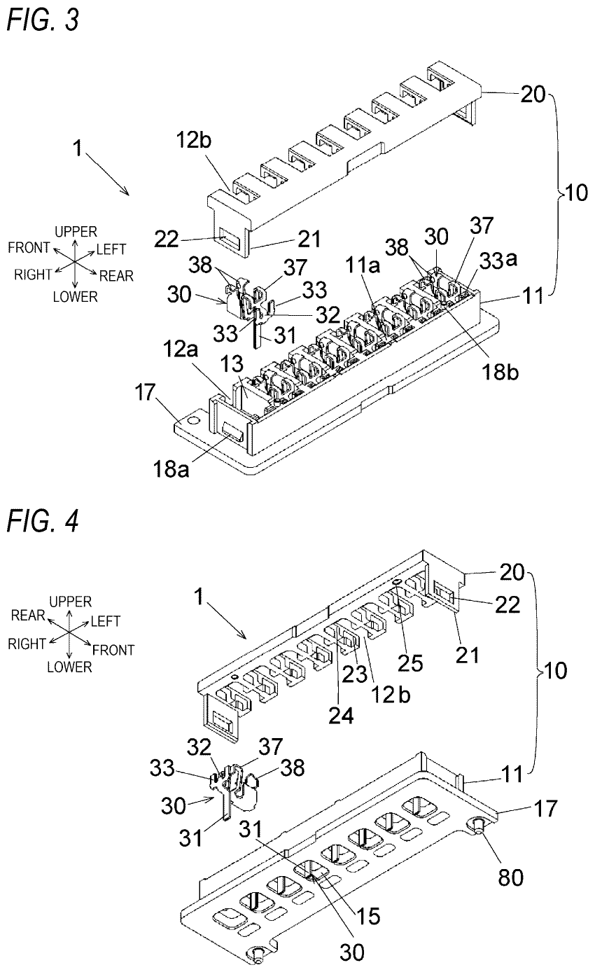

As can be seen from the exploded perspective view and the like of FIGS. 3 and 4, the housing 10 is a combination structure of a first housing portion 11 on the base portion side and a second housing portion 20 on the lid side fixed to the first housing portion 11. The reason for dividing the housing 10 into two is to enable the terminals 30 to be provided in the first housing portion 11 from above the first housing portion 11 before the second housing portion 20 is assembled, and there is no large opening for providing the terminals 30 on the bottom side of the first housing portion 11 facing the board 100 (FIG. 5). In the state shown in FIGS. 1 and 2 in which the first housing portion 11 and the second housing portion 20 are combined, the housing 10 has a connection opening 12 into which a connection counterpart contactor (for example, a plug of a metal plate) can be inserted and connected to the terminal 30. The connection opening 12 are aligned in the left-right direction across the front surface and the upper surface of the housing 10.

As shown in FIGS. 3, 7, and 8, the first housing portion 11 includes a connection notch 12a that constitutes a part of the connection opening 12 corresponding to each terminal 30, a terminal arrangement recess 13, a terminal through hole 14, and a potting recess 15. The connection notch 12a in the upper-lower direction and a connection notch 12b in the front-rear direction of the second housing portion 20 are continuous with each other to form the connection opening 12.

As shown in FIG. 7, the terminal through hole 14 penetrates vertically from the bottom surface of the terminal arrangement recess 13 toward the potting recess 15, and is preferably a small opening through which a leg portion 31 of the terminal 30 can be press-fitted. The terminal arrangement recess 13 opens to the upper side of the first housing portion 11 and is a large opening into which the terminal 30 can be inserted (press-fitted) and provided from above. The terminal arrangement recess 13 has a terminal holding groove 16 formed in the upper-lower direction, into which the terminal 30 is press-fitted to hold the terminal 30 in position. The terminal holding groove 16 is provided on the left and right side walls along the side wall surface on the back surface side of the terminal arrangement recess 13. The potting recess 15 for providing (filling) the sealing material 70 is opened on the lower side of the first housing portion 11, that is, on the bottom surface with a small area. The potting recess 15 further has a step 15a around the leg portion 31 of the terminal 30, and the depth in the upper-lower direction is partially increased around the leg portion 31 in order to fill the sealing material 70 therein. In the present embodiment, the bottom area (or the opening area) of the potting recess 15 is sufficiently smaller than the opening area of the terminal arrangement recess 13. Alternatively, the bottom area of the potting recess 15 may be equal to or larger than the opening area of the terminal arrangement recess 13.

As shown in FIGS. 2 and 4, the potting recess 15 according to the present embodiment has a rectangular shape with rounded corners when viewed from above. However, the shape of the potting recess 15 is not limited, and may be a polygon, a rectangle, a circle, an ellipse, an oval, or the like. The potting recess 15 may have a tapered shape when viewed from the side. The shape of the step 15a on the bottom surface of the potting recess 15 is not limited. In addition, the step 15a is not limited to one step, but may be a plurality of steps, and the periphery of the leg portion 31 of the terminal 30 may be convex or may be formed in a tapered shape.

The first housing portion 11 includes a flange portion 17 on the bottom side, and a mounting member 80 is held by the flange portion 17. The mounting member 80 is, for example, a metal member, is connected by soldering or the like to the board 100 (FIG. 5) on which the connector 1 is to be mounted, and fixes the connector 1 to the board 100. When the connector 1 is incorporated into an enclosure (not shown) or the like, an elastic member (not shown) such as a rubber sheet may be interposed between the upper surface of the flange portion 17 and the enclosure to ensure the waterproof property. The first housing portion 11 may have a structure that does not include the flange portion 17.

As shown in FIG. 3 and the like, in order to mount the second housing portion 20 on the first housing portion 11, engagement protrusions 18a are formed on both left and right side surfaces of the first housing portion 11. A columnar engagement protrusion 18b is formed on the upper end surface.

As shown in FIGS. 1, 3, 4, 8, and the like, the second housing portion 20 has, on the upper surface thereof, the connection notch 12b that forms a part of the connection opening 12, and includes tongue-shaped mounting portions 21 at both end portions in the left-right direction. The tongue-shaped mounting portion 21 has an engagement hole 22. The second housing portion 20 has an engagement recess 25 on the surface facing the first housing portion 11. When the second housing portion 20 is mounted on the first housing portion 11, the engagement hole 22 of the tongue-shaped mounting portion 21 is fitted to the engagement protrusion 18a that is located on both end surfaces of the first housing portion 11 in the left-right direction, and an engagement recess 25 is fitted to the columnar engagement protrusion 18b on the upper end surface of the first housing portion 11. As shown in FIG. 7, recesses 23 and 24 for avoiding contact with the terminal 30 are formed on the lower surface of the second housing portion 20, that is, on the surface facing the first housing portion 11.

As shown in FIGS. 3, 4, 7, 8, and the like, the terminal 30 is made of a metal material such as beryllium copper or titanium copper, and is a sheet metal component formed by pressing a plate-shaped metal. The terminal 30 may be formed by molding or cutting. The terminal 30 may be subjected to surface plating processing. In the present embodiment, the terminal 30 integrally includes the leg portion 31, a positioning portion 32, a positioning branch portion 33, a plate spring portion 37, and a contact portion 38.

The leg portion 31 is a connection portion (a mounting portion) that is electrically connected by soldering or the like to a conductive pattern (not shown) on the board 100 (FIG. 5) on which the connector 1 is to be mounted. The leg portion 31 according to the present embodiment is plate-shaped, extends in the upper-lower direction, penetrates the sealing material 70, and extends downward of the first housing portion 11. The positioning portion 32 is connected to the upper portion of the leg portion 31 via the bent portion and is adjacent to, and preferably abuts against, the side wall surface (the opposite side of the connection opening 12) of the terminal arrangement recess 13 of the first housing portion 11, and the positioning branch portion 33 is held in a press-fitted state in the terminal holding groove 16, thereby positioning the terminal 30 in the front-rear direction. The positioning branch portion 33 branches off from the positioning portion 32 on both sides in the left-right direction, and as shown in FIG. 7, a distal end surface 33a of the positioning branch portion 33 is exposed on an upper end surface 11a (the end surface of the terminal arrangement recess 13) side of the first housing portion 11 that faces the second housing portion 20. The distal end surface 33a of the positioning branch portion 33 is set to be flush with the upper end surface 11a of the first housing portion 11 or at a predetermined height position with respect to the upper end surface 11a. At the time of assembly, the height positions of the distal end surfaces 33a of the positioning branch portions 33 can be adjusted to a constant level using a jig or the like, so that it is possible to align the height positions of the terminals 30 with respect to the first housing portion 11 in the upper-lower direction. The leg portion 31 is located on the front side with respect to the positioning portion 32 via the bent portion, and the leg portion 31 is pulled out from the position near the center of the potting recess 15.

The plate spring portion 37 has a substantially inverted U shape when viewed from the side, and is continuous with the upper portion of the positioning portion 32. The plate spring portion 37 acts to give the contact portion 38 appropriate flexibility. The contact portion 38 is supported on the plate spring portion 37, and is exposed to the outside of the housing 10 from the connection opening 12. The contact portion 38 is divided into two parts on the left and right, and when a connection counterpart contactor (not shown) is inserted between the two parts, the contactor is clamped and electrically connected.

The sealing material 70 is, for example, urethane resin or epoxy resin, and is filled into the potting recess 15 so as to seal the opening of the terminal through hole 14, thereby sealing the gap between the terminal through hole 14 in the first housing portion 11 and the leg portion 31 of the terminal 30 to provide a watertight seal. The potting recess 15 includes the step 15a around the leg portion 31 of the terminal 30, so that the adhesion area between the sealing material 70 and the leg portion 31 and between the sealing material 70 and the inner surface of the potting recess 15 can be increased. When the terminal 30 is mounted on the board, the housing 10 may be deformed, for example, by heat generated by soldering. The influence of deformation of the housing 10 is lessened when the potting recess 15 is small in the part surrounding the terminal, and thus the bottom part of the potting recess 15 around the terminal 30 is narrowed. For example, when a gap between the terminal through hole 14 of the first housing portion 11 and the leg portion 31 of the terminal 30 can be ignored, the sealing material may not be used.

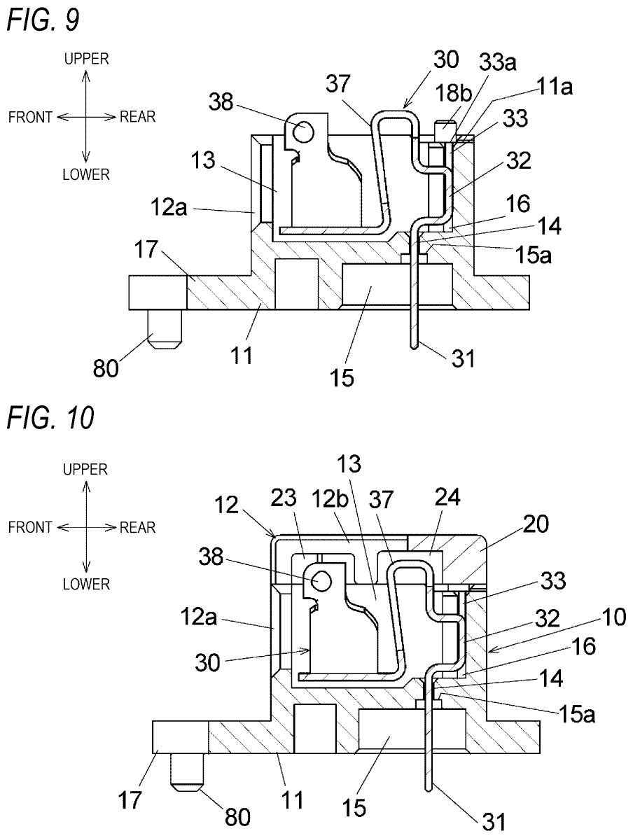

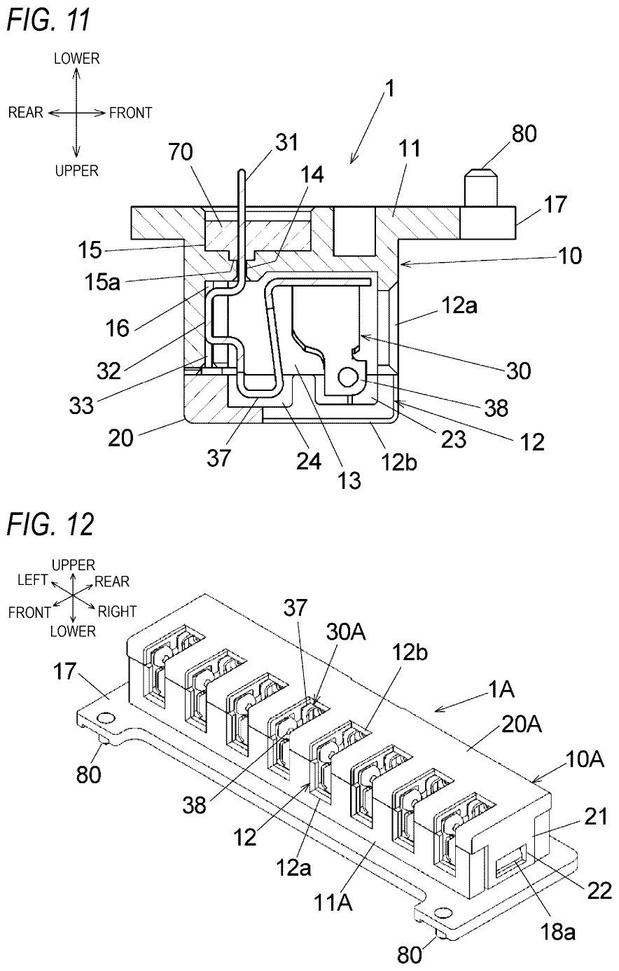

The assembly procedure for the connector 1 will be described with reference to FIGS. 9 to 11. First, as shown in FIG. 9, the leg portion 31 of the terminal 30 is inserted (press-fitted) into the terminal through hole 14 that is located in the bottom surface of the terminal arrangement recess 13 of the first housing portion 11, both side end edges of the positioning branch portion 33 are inserted (press-fitted) into the terminal holding groove 16, and the terminal 30 is provided in the terminal arrangement recess 13. At this time, the height positions of the terminals 30 are aligned by aligning the height of the distal end surface 33a of the positioning branch portion 33 and the height of the end surface 11a of the first housing portion 11 using a jig or the like. Next, as shown in FIG. 10, the second housing portion 20 is mounted on the first housing portion 11. At this time, as shown in FIGS. 1 and 8, the engagement hole 22 of the tongue-shaped mounting portion 21 that is formed in the second housing portion 20 is fitted to the engagement protrusion 18a of the first housing portion 11, and the engagement recess 25 of the second housing portion 20 is fitted (press-fitted) to the columnar engagement protrusion 18b of the first housing portion 11. Accordingly, the first housing portion 11 and the second housing portion 20 are integrated and become the housing 10. Then, as shown in FIG. 11, the housing 10 is turned over, the potting recess 15 on the bottom surface side of the first housing portion 11 faces upward, and the potting processing is performed. That is, the potting recess 15 is filled with the uncured sealing material 70 which is a potting liquid. At this time, since the sealing material 70 has an appropriate viscosity, the sealing material 70 does not enter the inside of the terminal arrangement recess 13. Since the leg portion 31 of the terminal 30 that is led out from the terminal through hole 14 to the outside of the housing is at a position that is separated from all the side wall surfaces of the potting recess 15, the entire periphery of the leg portion 31 is surrounded by the sealing material 70 without any gap. Thereafter, the sealing material 70 is cured. Examples of the curing method include thermal curing and curing by mixing two liquids.

According to the first embodiment, the following effects can be achieved.
(1) The housing 10 has a combined structure of the first housing portion 11 having the terminal through hole 14 and the second housing portion 20 fixed to the first housing portion 11, and the first housing portion 11 has an opening on the side facing the second housing portion 20 through which the terminal 30 can be provided from above. Therefore, there is no need to form a large opening for providing the terminal 30 in the housing 10 on the side of the terminal 30 on which the leg portion 31 is led out. Therefore, the waterproof structure can be achieved by sealing in a watertight manner the gap between the terminal through hole 14 formed in the first housing portion 11 and the leg portion 31 of the terminal 30 with the sealing material 70. For example, in order to provide the connector in Patent Literature 1 with a waterproof function, an additional member is required to form a potting space for the sealing material, which increases the height of the connector by that amount. However, in the present embodiment, no additional members are required, and the connector can be made smaller, particularly with a lower height.
(2) In a state in which the first housing portion 11 and the second housing portion 20 are combined, the housing 10 has the connection opening 12 into which the counterpart contactor is inserted. Therefore, the connection opening 12 can be easily formed extending from the front surface to the upper surface of the housing 10. The housing 10 is divided into the first housing portion 11 and the second housing portion 20, and is highly versatile. For example, by changing the shape of one of the housing portions to match the connection counterpart contactor, the housing can be used for connection counterpart contactors of various shapes.
(3) The terminal through hole 14 is located on the bottom surface of the potting recess 15 that is filled with the sealing material 70, and the sealing material 70 is provided over the entire circumference of the leg portion 31 of the terminal 30. Therefore, the watertight sealing effect is more reliable as compared with a case in which the leg portion 31 is pulled out along the wall surface of the potting recess 15.
(4) The bottom surface area (or the opening area) of the potting recess 15 that is filled with the sealing material 70 is set to be smaller than the opening area of the terminal arrangement recess 13 in which the terminal 30 can be provided, and the sealing material 70 can be saved to an appropriate amount.
(5) In the potting recess 15 that is filled with the sealing material 70, the step 15a (or a tapered recess or the like) is formed around the periphery where the leg portion 31 of the terminal 30 protrudes. Due to the step 15a, the depth of the sealing material 70 filled around the leg portion 31 is larger than other portions, and the potting recess 15 around the leg portion 31 becomes narrower. The influence on the sealing material 70 when the housing 10 is deformed is less when the area surrounding the leg portion 31 of the potting recess 15 is smaller. Therefore, by forming the step 15a, even if the housing is deformed due to the heat of soldering and the like, the influence on the sealing material 70 can be reduced, leading to an improved watertight effect.
(6) Since the potting recess 15 that is formed in the first housing portion 11 is open on the opposite side to the side facing the second housing portion 20, the width of the housing 10 in the front-rear direction does not increase even when compared to a connector that does not take waterproofing into consideration.
(7) The terminal 30 includes a positioning branch portion 33, and the distal end surface 33a of the positioning branch portion 33 is set to be flush with the upper end surface 11a of the first housing portion 11 facing the second housing portion 20 or at a predetermined height position with respect to the upper end surface 11a, so that it is possible to position the terminal 30 in the height direction without touching the plate spring portion 37 of the terminal 30.
(8) The housing 10 has a structure in which the first housing portion 11 and the second housing portion 20 are integrally fitted together, so that the two can be combined without misalignment, and the housing 10 can be easily assembled.

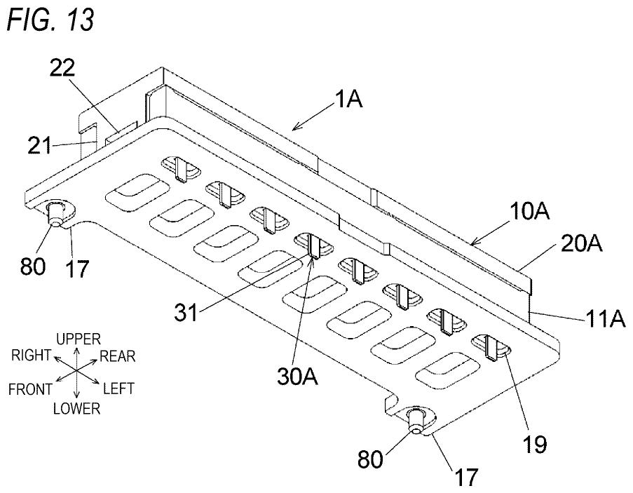

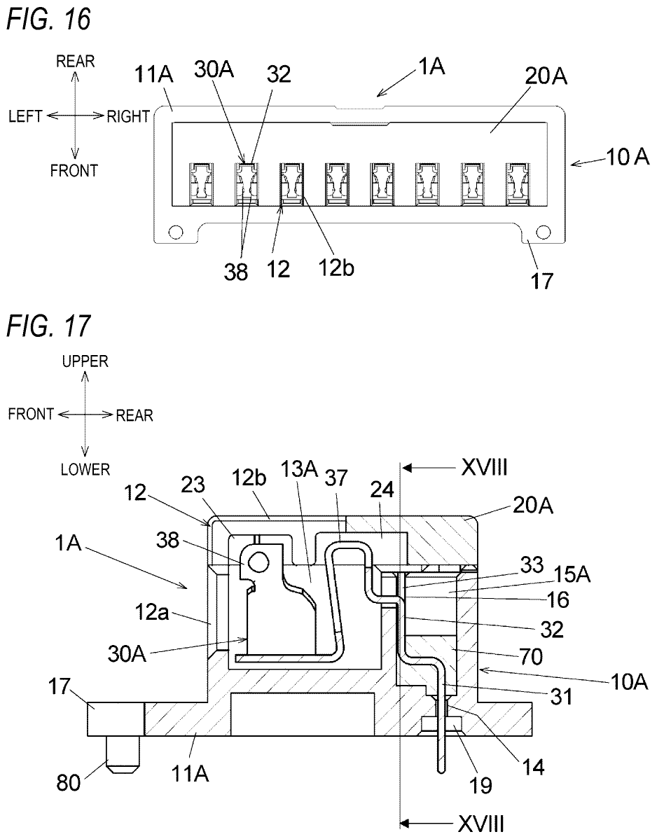

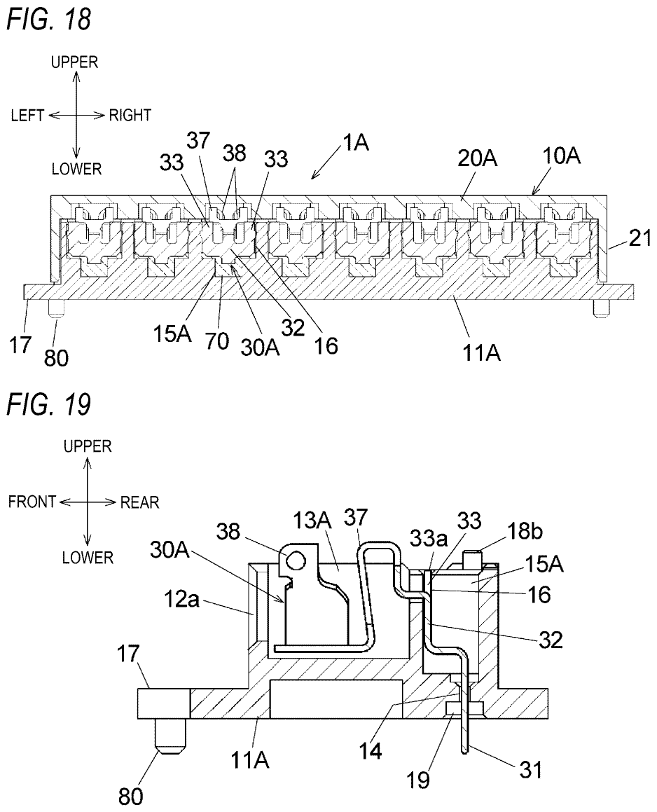

A connector according to a second embodiment of the present invention will be described with reference to FIGS. 12 to 21. In the connector 1 according to the first embodiment described above, the potting recess 15 is formed on the side facing the board 100 on the bottom surface of the housing. Therefore, the housing needs to be turned upside down during the potting processing. In a connector 1A according to the second embodiment, a structure that enables the potting processing without inverting a housing 10A is shown.

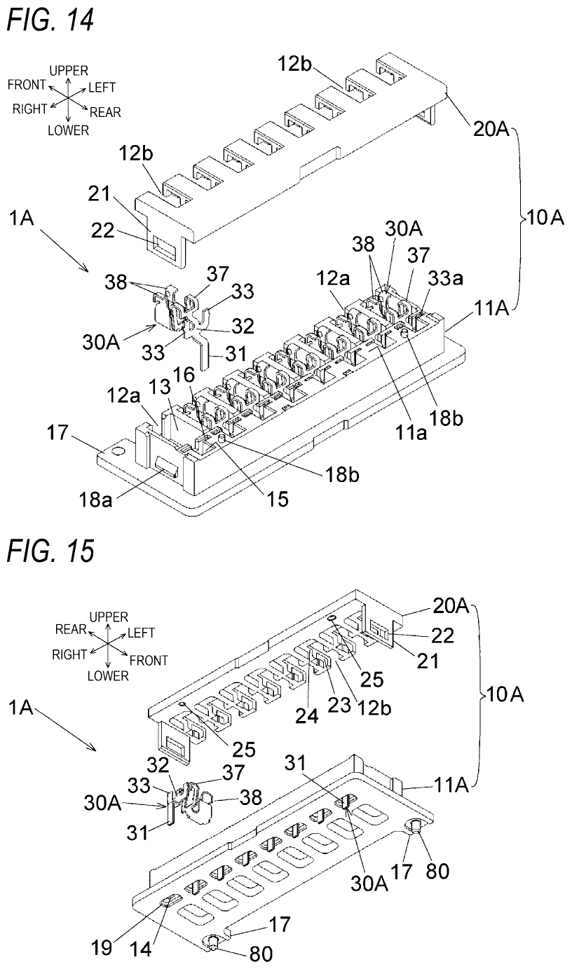

As shown in FIGS. 14, 17, and the like, the housing 10A of the connector 1A is a combination structure of a first housing portion 11A on the base portion side and a second housing portion 20A on the lid side fixed to the first housing portion 11A. As a difference from the first embodiment, in the first housing portion 11A according to the second embodiment, a terminal arrangement recess 13A and a potting recess 15A are adjacent to each other, and both are open upward. The terminal through hole 14 is located in the bottom surface of the potting recess 15A. A small recess 19 into which the terminal through hole 14 opens is formed in the bottom surface of the first housing portion 11A.

The terminal 30A includes the leg portion 31, the positioning portion 32, the positioning branch portion 33, the plate spring portion 37, and the contact portion 38, similarly to the first embodiment. In the second embodiment, the positioning portion 32 is adjacent to, and preferably abuts against, the side wall surface of the potting recess 15A, and the positional relationship between the leg portion 31 and the positioning portion 32 connected to the leg portion 31 via the bent portion is changed from the terminal 30 according to the first embodiment. As shown in FIG. 17, the terminal holding groove 16 that holds the positioning branch portion 33 of the terminal 30A in the press-fitted state is formed on the left and right side walls along the side wall surface adjacent to the terminal arrangement recess 13A of the potting recess 15A.

The other configuration of the connector 1A is the same as that in the first embodiment described above.

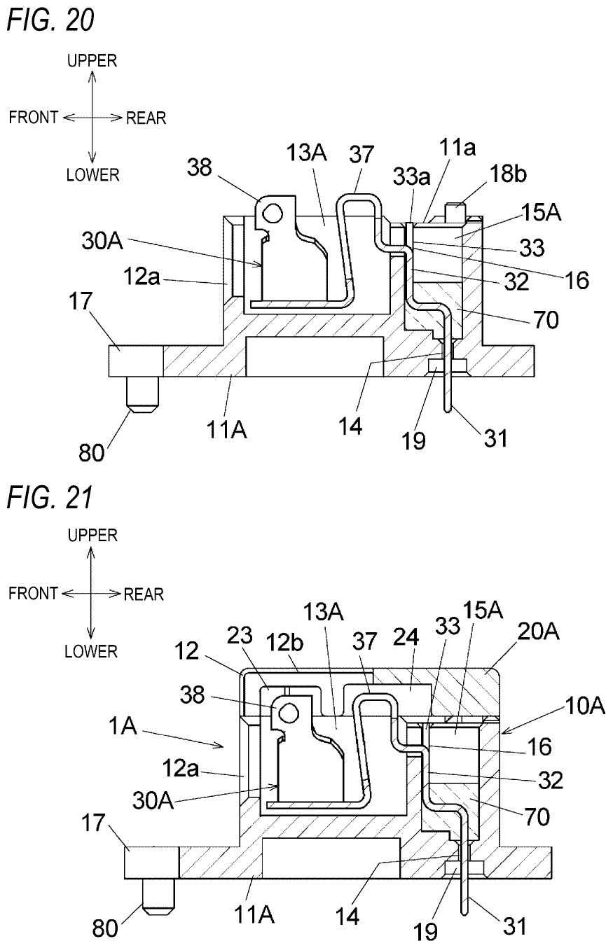

The assembly procedure for the connector 1A will be described with reference to FIGS. 19 to 21. First, as shown in FIG. 19, the leg portion 31 of the terminal 30A is inserted (press-fitted) into the terminal through hole 14 that is located in the bottom surface of the potting recess 15A of the first housing portion 11A, both side end edges of the positioning branch portion 33 are inserted (press-fitted) into the terminal holding groove 16, the plate spring portion 37 and the contact portion 38 of the terminal 30A are arranged in the terminal arrangement recess 13A, and the positioning portion 32, the positioning branch portion 33, and the leg portion 31 are arranged in the potting recess 15A. At this time, the height positions of the terminals 30A are aligned by aligning the heights of the distal end surfaces 33a of the positioning branch portions 33 using a jig or the like. Next, as shown in FIG. 20, the potting recess 15A is filled with the uncured sealing material 70 which is a potting liquid. At this time, since the sealing material 70 has an appropriate viscosity, the sealing material 70 does not leak out to the bottom surface side of the housing 10A. Since the leg portion 31 of the terminal 30A is at a position that is separated from all the side wall surfaces of the potting recess 15A, the entire periphery of the leg portion 31 is surrounded by the sealing material 70 without any gap. Thereafter, as shown in FIG. 21, the second housing portion 20A is mounted on the first housing portion 11A. At this time, as shown in FIG. 14 and the like, the engagement hole 22 of the tongue-shaped mounting portion 21 that is formed in the second housing portion 20A is fitted to the engagement protrusion 18a of the first housing portion 11A, and the engagement recess 25 of the second housing portion 20A is fitted to the columnar engagement protrusion 18b of the first housing portion 11A, so that the first housing portion 11A and the second housing portion 20A are integrated with each other.

According to the second embodiment, since the potting recess 15A of the first housing portion 11A filled with the sealing material 70 is open to the side facing the second housing portion 20A, that is, on the same side as the terminal arrangement recess 13A, the insertion and arrangement of the terminal 30A into the first housing portion 11A and the potting processing of the sealing material 70 into the potting recess 15A can be performed from above the first housing portion 11A. That is, the first housing portion 11A does not need to be turned upside down during the potting processing, which is advantageous in terms of improving the efficiency of the manufacturing process.

The potting recess 15A is formed adjacent to the terminal arrangement recess 13A in the front-rear direction, which is advantageous in terms of achieving a smaller height than the first embodiment in which the potting recess is formed on the bottom board side. Other configurations are similar to those in the first embodiment described above.

Embodiments and modifications of the present invention have been described above with reference to the drawings, but these embodiments and modifications are examples of the present invention, and various configurations other than those described above can also be used.

The terminal provided in the housing of the connector can be appropriately changed to match the shape of the connection counterpart contactor. The shape of the leg portion of the terminal connected to the board can also be appropriately changed. For example, the cross section may have a circular shape, a thin plate shape, a polygonal shape, or the like.

The method for integrating the first housing portion and the second housing portion that are constitute the housing is not limited to the embodiment described above. For example, a recessed and protruding fitting shape other than that in the embodiment may be used, and the first housing portion and the second housing portion may be integrated by adhesion, screw fastening, or the like. The recessed and protruding fitting and adhesion may be used in combination.

In the second embodiment, the sealing material may be potted from both upper and lower sides of the first housing portion.

According to the present description, a connector according to the following aspects is provided.

### Aspect 1

A connector including:
a housing; and
a terminal that is accommodated in the housing, and a part of which extends to an outside of the housing,
in which the housing includes a first housing portion having a terminal through hole through which a part of the terminal passes, and a second housing portion fixed to the first housing portion, and
in which the terminal is accommodated in an accommodating space formed by the first housing portion and the second housing portion in a state of partially passing through the terminal through hole by fixing the second housing portion to the first housing portion.

In the structure in the related art as shown in Patent Literature 1, when a large opening for providing a terminal is sealed with a sealing material, it is necessary to seal the opening with, for example, a lid in order to prevent the sealing material from leaking to the terminal side. However, according to the aspect 1 described above, a separate component such as a lid is not required, and even when the waterproof property is required, miniaturization, particularly a low height, can be achieved.

### Aspect 2

The connector further includes a sealing material configured to seal the terminal through hole.

According to the aspect 2 described above, the waterproof property can be ensured by sealing the terminal through hole with the sealing material.

### Aspect 3

In the connector, the first housing portion has a recess that is filled with the sealing material, the terminal through hole is located in a bottom surface of the recess, and the sealing material is provided over an entire circumference of the terminal.

According to the aspect 3 described above, since the sealing material is provided over the entire circumference of the terminal, as compared with a case in which the terminal is pulled out along the wall surface of the recess, the watertight sealing effect can be attained more reliably.

### Aspect 4

In the connector, a bottom surface area of the recess is smaller than an opening area of the opening in which the terminal is configured to be provided.

According to the aspect 4 described above, since the bottom surface area of the potting recess is smaller than the opening area of the terminal arrangement recess, the sealing material can be saved to an appropriate amount.

### Aspect 5

In the connector, the recess has a step around the terminal.

According to the aspect 5 described above, the influence caused by deformation of the housing can be reduced by narrowing the bottom portion of the recess around the terminal.

### Aspect 6

In the connector, the recess is open to a side facing the second housing portion.

According to the aspect 6 described above, since the recess is open to the side facing the second housing portion, it is not necessary to invert the first housing portion when the recess is filled with the sealing material, which is advantageous in terms of improving the efficiency of the manufacturing process. In addition, the height of the housing in the upper-lower direction can be reduced.

### Aspect 7

In the connector, the recess is open to a side opposite to a side facing the second housing portion.

According to the aspect 7 described above, since the recess is open to the side opposite to the side facing the second housing portion, the width of the housing in the front-rear direction can be reduced.

### Aspect 8

In the connector, the terminal includes a branch portion, and a distal end surface of the branch portion is flush with an end surface of the first housing portion facing the second housing portion or at a predetermined height position with respect to the end surface.

According to the aspect 8 described above, the terminal can be positioned in the height direction by adjusting the height of the distal end surface of the positioning branch portion.

### Aspect 9

In the connector, the first housing portion and the second housing portion are fitted and integrated with each other.

According to the aspect 9 described above, it is possible to combine the first housing portion and the second housing portion without misalignment, and it is easy to assemble the housing.

### Aspect 10

In the connector,
the housing has a connection opening, and
the terminal is exposed to the outside of the housing through the connection opening.

According to the aspect 10 described above, it is possible to form the connection opening from the front surface to the upper surface of the housing, and the degree of freedom designing when the housing is divided into the first housing portion and the second housing portion is large.

### REFERENCE SIGNS LIST

1, 1A: connector
10, 10A: housing
11, 11A: first housing portion
12: connection opening
13, 13A: terminal arrangement recess
14: terminal through hole
15, 15A: potting recess
20, 20A: second housing portion
30, 30A: terminal
31: leg portion
32: positioning portion
33: positioning branch portion
37: plate spring portion
38: contact portion
70: sealing material
80: mounting member
100: board

1. A connector comprising:
a housing; and
a terminal that is accommodated in the housing, and a part of which extends to an outside of the housing,
wherein the housing includes a first housing portion having a terminal through hole through which a part of the terminal passes, and a second housing portion fixed to the first housing portion, and
wherein the terminal is accommodated in an accommodating space formed by the first housing portion and the second housing portion in a state of partially passing through the terminal through hole by fixing the second housing portion to the first housing portion.

2. The connector according to claim 1, further comprising
a sealing material configured to seal the terminal through hole.

3. The connector according to claim 2,
wherein the first housing portion has a recess that is filled with the sealing material, the terminal through hole is located in a bottom surface of the recess, and the sealing material is provided over an entire circumference of the terminal.

4. The connector according to claim 3,
wherein a bottom surface area of the recess is smaller than an opening area of the opening in which the terminal is configured to be provided.

5. The connector according to claim 3,
wherein the recess has a step around the terminal.

6. The connector according to claim 3,
wherein the recess is open to a side facing the second housing portion.

7. The connector according to claim 3,
wherein the recess is open to a side opposite to a side facing the second housing portion.

8. The connector according to claim 1,
wherein the terminal includes a branch portion, and a distal end surface of the branch portion is flush with an end surface of the first housing portion facing the second housing portion or at a predetermined height position with respect to the end surface.

9. The connector according to claim 1,
wherein the first housing portion and the second housing portion are fitted and integrated with each other.

10. The connector according to claim 1,
wherein the housing has a connection opening, and
wherein the terminal is exposed to the outside of the housing through the connection opening.
